(19) United States
(12) Patent Application Publication
(10) Pub. No.: US 2010/0166609 A1
(43) Pub. Date: Jul. 1, 2010

(54) MICROCHANNEL CHIP

(75) Inventors: Hisashi HAGIWARA, Kanagawa (JP); Yoshinori Mishina, Kanagawa (JP); Seika Yamashita, Kanagawa (JP)

Correspondence Address: MCDERMOTT WILL & EMERY LLP, 600 13TH STREET, N.W., WASHINGTON, DC, 20005-3096, US

(73) Assignee: AIDA ENGINEERING, LTD.

(21) Appl. No.: 12/646,128

(22) Filed: Dec. 23, 2009

(30) Foreign Application Priority Data
Dec. 26, 2008 (JP) 2008-332008

(51) Int. Cl. B01J 19/00; B01D 17/00

(52) U.S. Cl. 422/68.1; 422/240; 422/255

(57) ABSTRACT

A micro-channel chip comprising a first substrate and a second substrate bonded together, characterized in that at least one patch of a non-adhesive thin-film layer for generating a micro-channel is formed on the mating surface of at least one of the two substrates, a port that is open to the atmosphere is provided in the first substrate, and at least one end portion of the non-adhesive thin-film layer is communicably connected to the port, further characterized in that an underplate made of a material that is difficult to deform by itself is provided on the underside of the second substrate, the underplate has a recess at the interface with the second substrate that extends from a position that is short of the center of the port toward the non-adhesive thin-film layer, and the width of the recess is greater than that of the non-adhesive thin-film layer.

### CROSS REFERENCE TO RELATED APPLICATIONS

The present application claims priority under 35 U.S.C. §119 to Japanese Patent Application No. 2008-332008, filed Dec. 26, 2008, which is incorporated herein by reference.

### TECHNICAL FIELD

The present invention relates to a micro-channel chip. More particularly, the present invention relates to a micro-channel chip that has non-adhesive layers and which requires a fairly low pressure to inflate those areas which correspond to the non-adhesive layers.

### BACKGROUND ART

Devices commonly known as “micro-total analysis systems (μTAS)” or “lab-on-chip” comprise a substrate and microstructures such as micro-channels and ports that are provided in the substrate to form channels of specified shapes. It has recently been proposed that a variety of operations such as chemical reaction, synthesis, purification, extraction, generation and/or analysis be performed on substances in the microstructures and some of the proposals have already been commercialized. Structures that are fabricated for this purpose and which have microstructures such as micro-channels and ports provided in the substrate are collectively referred to as “micro-channel chips” or “micro-fluid devices.”

Micro-channel chips find use in a wide variety of applications including gene analysis, clinical diagnosis, drug screening, and environmental monitoring. Compared to devices of the same type in usual size, micro-channel chips have various advantages including (1) extremely smaller amounts of samples and reagents that need to be used, (2) shorter analysis time, (3) higher sensitivity, (4) portability to the site for on-site analysis, and (5) one-way use.

A conventional micro-channel chip of the type described in the official gazette of JP 2001-157855 A (Patent Document 1) is shown in FIGS. 19A and 19B, where it is indicated by numeral 100. As shown, the micro-channel chip 100 comprises a first substrate 102 that is formed of a material such as polydimethylsiloxane (PDMS) which is a silicone resin of elastomer type, at least one hollow micro-channel 104 formed in the first substrate 102, ports 105 and 106 formed in at least one end of the hollow micro-channel 104 to serve as an input and an output port, and a second substrate 108 that is bonded to the underside of the substrate 102 and which is formed of a transparent or opaque material (for example, glass or PDMS). The second substrate 108 helps seal the bottoms of the ports 105 and 106, as well as the micro-channel 104.

A problem with the conventional micro-channel chip 100 of the type described in Patent Document 1 is its relatively high manufacturing cost since it is produced by the so-called photolithographic technology that is commonly used in semiconductor fabrication. What is more, in the case of delivering a medium such as a liquid from the port 105 to the port 106, the conventional micro-channel chip 100 is sometimes equipped with a fluid control element such as a micro-valve that is provided halfway down the hollow micro-channel 104 in order to control the flow of the medium [see, for example, FIG. 3 accompanying the official gazette of JP 2001-304440 A (Patent Document 2)]. However, the micro-valve of this design is so complex in structure that it is not easy to form, and if it is to be installed in actual applications, the manufacturing cost of the micro-channel chip 100 will be further increased.

In order to solve the above-mentioned problems with the conventional micro-channel chip, we filed an international patent application on a micro-channel chip having non-adhesive layers such that those areas which corresponded to them had no channel capacity when the chip was not used but which, during its use, could be inflated by pressure application to form channels of a certain capacity. The international application was published in the official gazette of WO 2007/094254 A1. FIGS. 20A and 20B show the micro-channel chip in outline plan and sectional views, in which it is indicated by numeral 100A. The micro-channel chip 100A shown in FIGS. 20A and 20B is basically of the same design as the conventional micro-channel chip 100 in that it comprises the first substrate 102 and the second substrate 108, the first substrate 102 having ports 105 and 106 provided in it that should serve as an inlet and an outlet for a medium such as a liquid or gas. The first substrate 102 and the second substrate 108 are bonded to each other, except in areas where a non-adhesive thin-film layer 110 and the ports 105 and 106 are located. The non-adhesive thin-film layer 110 is a region equivalent to that area of the conventional micro-channel chip 100 which should serve to form the micro-channel 104. However, when the chip is not being used, the ports 105 and 106 are interrupted from each other by the non-adhesive thin-film layer 110, so a medium such as a liquid or gas cannot be delivered from one port to the other.

As shown in FIG. 21A, the micro-channel chip 100A has an adapter 114 provided in the opening of the port 105 through which to introduce a liquid or gas, and a feed tube 116 is connected to this adapter 114. Although not shown, the other end of the feed tube 116 is connected to a suitable sample solution supply means and/or pressure applying means (e.g. a micro-pump or a syringe). When a liquid of interest has been injected into the port 105, a gas (e.g. air) is forced in through the feed tube 116 at high pressure (say, 10 kPa to 100 kPa). Alternatively, a liquid of interest is injected into the port 105 with a positive pressure being applied simultaneously, whereupon as shown in FIG. 21B, only that part of the first substrate that corresponds to the non-adhesive thin-film layer 110 is slightly inflated to create a gap 118; this gap functions as a micro-channel and enables the liquid and/or gas within the port 105 to be transferred to the port 106. If the outer surface of the top of that area of the first substrate 102 which corresponds to the non-adhesive thin-film layer 110 is depressed with a finger or the like, the inflating gap 118 can simply be closed. As a result, the micro-channel chip 100A shown in FIGS. 20A and 20B, although it is not equipped with any special constituent element such as the conventional micro-valve, can exhibit a comparable effect to what is achieved by the micro-valve.

Also, we filed a patent application on a micro-channel chip having non-adhesive layer for a micro-channel and another non-adhesive layer for a shutter channel which can be operated to function as a micro-valve for opening or closing the micro-channel. This application was published in the official gazette of US 2008/0057274 A1.

If the number of ports is small, say two to four, there will be no great inconvenience in connecting the adapter 114 to each of the ports and performing such operations as feeding a liquid and/or applying pressure; however, if the number of ports is as much as several tens, the adapter connecting operation alone takes such a prolonged time that the efficiency of the analytical operation is reduced. In addition, for realizing an automatic analyzer that uses the micro-channel chip 100A of FIGS. 20A and 20B, it has also been desired to develop a micro-channel chip that does not use the adapter 114 but which yet allows a multiple of ports to be supplied with a liquid and/or pressure simultaneously.

### SUMMARY OF INVENTION

An object, therefore, of the present invention is to improve a micro-channel chip that comprises a first and a second substrate and which has a non-adhesive thin-film layer such that the area which corresponds to it has no channel capacity when the chip is not used but which, during its use, can be inflated by pressure application to form a channel of a certain capacity, the improvement being such that the area of the micro-channel chip which corresponds to the non-adhesive thin-film layer can be inflated by the necessary and sufficient amount when one uses a pressure application/liquid supply support member that can be detachably provided on the top surface of the micro-channel chip, which is made of a rigid material, and which allows feed tubes to be set at a time on a plurality of ports in the micro-channel chip.

As a means of solving the problem described above, the present invention provides a micro-channel chip that comprises a first substrate and a second substrate bonded together, characterized in that at least one patch of a non-adhesive thin-film layer for generating a micro-channel is formed on the mating surface of at least one of the two substrates, a port that is open to the atmosphere is provided in the first substrate, and at least one end portion of the non-adhesive thin-film layer is communicably connected to the port, further characterized in that an underplate made of a material that is difficult to deform by itself is provided on the underside of the second substrate, the underplate has a recess at the interface with the second substrate that extends from a position that is short of the center of the port toward the non-adhesive thin-film layer, and the width of the recess is greater than that of the non-adhesive thin-film layer.

According to this invention, by virtue of the recess formed in the underplate, the second substrate where no port is provided can deform in such a way that it flexes into the recess. As a result of this deformation, a gap is created in an end portion of the non-adhesive thin-film layer between the two substrates and through this gap, the part of the substrate which corresponds to the non-adhesive thin-film layer can be inflated at a fairly low pressure to create a void that functions as a micro-channel.

In one embodiment of the present invention, the recess extends from a position that is short of the center of the port to cover only a part of the length of the non-adhesive thin-film layer.

According to this embodiment, the recess is formed in the underplate in such a way that it is offset from the port toward the non-adhesive thin-film layer and, thus, that part of the substrate which corresponds to the non-adhesive thin-film layer can be inflated with greater ease.

In another embodiment of the present invention, the recess extends from a position that is short of the center of the port to cover the entire length of the non-adhesive thin-film layer.

According to this embodiment, the recess in the underplate extends to cover the entire part of the non-adhesive thin-film layer and, thus, by inflating that part of the substrate which corresponds to the non-adhesive thin-film layer, there can be created a void that functions as a micro-channel and which has a sufficient size that corresponds to the depth of the recess.

In still another embodiment of the present invention, the first substrate is made of a rigid material that can be permanently bonded to polydimethylsiloxane (PDMS) whereas the second substrate is made of PDMS.

According to this embodiment, the first substrate is formed of a rigid material, so even if a holding lid for pressure application and medium feeding that is fitted with O-rings is forcibly depressed onto the port in the first substrate, there will be no such inconvenience as the first substrate deflecting to damage sealability.

In yet another embodiment of the present invention, both the first substrate and the second substrate are made of PDMS.

According to this embodiment, the first and the second substrate can be permanently bonded in the most reliable way.

In a still further embodiment of the present invention, the first substrate made of PDMS is provided on its top with an over-plate made of a rigid material.

According to this embodiment, the over-plate made of a rigid material that is provided on top of the first substrate made of PDMS ensures that even if a holding lid for pressure application and medium feeding that is fitted with O-rings is forcibly depressed onto the port in the first substrate, there will be no such inconvenience as the first substrate deflecting to damage sealability.

In another embodiment of the present invention, the underplate is formed of at least one material selected from the group consisting of metals, plastics, rubbers, glasses, ceramics, woods, and synthetic papers and is either bonded to or detachably provided on the underside of the second substrate.

In this embodiment, the underplate, which is formed of the materials listed above that are difficult to deform by themselves, can positively hold the overlying substrate without causing it to deflect. In addition, if this underplate is provided detachably on the underside of the second substrate, it can be used more than once, which contributes to economy.

As another means of solving the aforementioned problem, the present invention provides a micro-channel chip that comprises, in order from top to bottom, a first substrate, a second substrate, and a third substrate bonded together, characterized in that at least one patch of a non-adhesive thin-film layer for generating a fluid control element is formed on the mating surface of at least one substrate selected from between the first substrate and the second substrate, at least one patch of a non-adhesive thin-film layer for generating a micro-channel is formed on the mating surface of at least one substrate selected from between the second substrate and the third substrate, the non-adhesive thin-film layer for generating a fluid control element is formed in such a way that it overlaps, with the second substrate being interposed, at least a part of the non-adhesive thin-film layer for generating a micro-channel, and the first substrate is provided with a first port and a second port, the first port being deep enough to reach the second substrate for opening to the atmosphere and to which at least one end portion of the non-adhesive thin-film layer for generating a micro-channel is communicably connected, and the second port being open to the atmosphere and to which at least one end portion of the non-adhesive thin-film layer for generating a fluid control element is communicably connected, further characterized in that an underplate made of a material that is difficult to deform by itself is provided on the underside of the third substrate, the underplate has a first recess and a second recess provided at the interface with the third substrate, the first recess extending from a position that is short of the center of the first port toward the non-adhesive thin-film layer for generating a micro-channel, the second recess extending from a position in that part of the non-adhesive thin-film layer for generating a fluid control element which does not overlap the non-adhesive thin-film layer for generating a micro-channel and that is short of the center of the second port toward the non-adhesive thin-film layer for generating a fluid control element in that part which does not overlap the non-adhesive thin-film layer for generating a micro-channel, the width of the first recess being greater than that of the non-adhesive thin-film layer for generating a micro-channel, as well as the width of the non-adhesive thin-film layer for generating a fluid control element in the part which overlaps the non-adhesive thin-film layer for generating a micro-channel.

According to this invention, the non-adhesive thin-film layer for generating a micro-channel and the non-adhesive thin-film layer for generating a fluid control element cooperate to enable partial closure of the micro-channel from above.

As still another means of solving the aforementioned problem, the present invention provides a micro-channel chip that comprises, in order from top to bottom, a first substrate, a second substrate, and a third substrate bonded together, characterized in that at least one patch of a non-adhesive thin-film layer for generating a micro-channel is formed on the mating surface of at least one substrate selected from between the first substrate and the second substrate, at least one patch of a non-adhesive thin-film layer for generating a fluid control element is formed on the mating surface of at least one substrate selected from between the second substrate and the third substrate, the non-adhesive thin-film layer for generating a fluid control element is formed in such a way that it overlaps, with the second substrate being interposed, at least a part of the non-adhesive thin-film layer for generating a micro-channel, and the first substrate is provided with a first port and a second port, the first port being open to the atmosphere and to which at least one end portion of the non-adhesive thin-film layer for generating a micro-channel is communicably connected, and the second port being deep enough to reach the second substrate for opening to the atmosphere and to which at least one end portion of the non-adhesive thin-film layer for generating a fluid control element is communicably connected, further characterized in that an underplate made of a material that is difficult to deform by itself is provided on the underside of the third substrate, the underplate has a first recess and a second recess provided at the interface with the third substrate, the first recess extending from a position that is short of the center of the first port toward the non-adhesive thin-film layer for generating a micro-channel, the second recess extending from a position in that part of the non-adhesive thin-film layer for generating a fluid control element which does not overlap the non-adhesive thin-film layer for generating a micro-channel and that is short of the center of the second port toward the non-adhesive thin-film layer for generating a fluid control element in the part which does not overlap the non-adhesive thin-film layer for generating a micro-channel, the width of the first recess being greater than that of the non-adhesive thin-film layer for generating a micro-channel but smaller than the width of the non-adhesive thin-film layer for generating a fluid control element in the part which overlaps the non-adhesive thin-film layer for generating a micro-channel.

According to this invention, the non-adhesive thin-film layer for generating a micro-channel and the non-adhesive thin-film layer for generating a fluid control element cooperate to enable partial closure of the micro-channel from below.

As yet another means of solving the aforementioned problem, the present invention provides a micro-channel chip that comprises, in order from top to bottom, a first substrate, a second substrate, a third substrate, and a fourth substrate bonded together, characterized in that at least one patch of a first non-adhesive thin-film layer for generating a fluid control element is formed on the mating surface of at least one substrate selected from between the first substrate and the second substrate, at least one patch of a non-adhesive thin-film layer for generating a micro-channel is formed on the mating surface of at least one substrate selected from between the second substrate and the third substrate, and at least one patch of a second non-adhesive thin-film layer for generating a fluid control element is formed on the mating surface of at least one substrate selected from between the third substrate and the fourth substrate, the first non-adhesive thin-film layer for generating a fluid control element is formed in such a way that it overlaps, with the second substrate being interposed, at least a part of the non-adhesive thin-film layer for generating a micro-channel, the second non-adhesive thin-film layer for generating a fluid control element is formed in such a way that it overlaps, with the third substrate being interposed, at least a part of the non-adhesive thin-film layer for generating a micro-channel, and the first substrate is provided with a first port, a second port, and a third port, the first port being deep enough to reach the second substrate for opening to the atmosphere and to which at least one end portion of the non-adhesive thin-film layer for generating a micro-channel is communicably connected, the second port being open to the atmosphere and to which at least one end portion of the first non-adhesive thin-film layer for generating a fluid control element is communicably connected, and the third port being deep enough to reach the third substrate for opening to the atmosphere and to which at least one end portion of the second non-adhesive thin-film layer for generating a fluid control element is communicably connected, further characterized in that an underplate made of a material that is difficult to deform by itself is provided on the underside of the fourth substrate, the underplate has a first recess, a second recess, and a third recess provided at the interface with the fourth substrate, the first recess extending from a position that is short of the center of the first port toward the non-adhesive thin-film layer for generating a micro-channel, the second recess extending from a position in that part of the first non-adhesive thin-film layer for generating a fluid control element which does not overlap the non-adhesive thin-film layer for generating a micro-channel and that is short of the center of the second port toward the first non-adhesive thin-film layer for generating a fluid control element in that part which does not overlap the non-adhesive thin-film layer for generating a micro-channel, the third recess extending from a position in that part of the second non-adhesive thin-film layer for generating a fluid control element which does not overlap the non-adhesive thin-film layer for generating a micro-channel and that is short of the center of the third port toward the second non-adhesive thin-film layer for generating a fluid control element in that part which does not overlap the non-adhesive thin-film layer for generating a micro-channel, the width of the first recess being greater than that of the non-adhesive thin-film layer for generating a micro-channel as well as the width the first non-adhesive thin-film layer for generating a fluid control element in of that part which overlaps the non-adhesive thin-film layer for generating a micro-channel but smaller than the width of the second non-adhesive thin-film layer for generating a fluid control element in that part which overlaps the non-adhesive thin-film layer for generating a micro-channel.

According to this invention, the non-adhesive thin-film layer for generating a micro-channel and the non-adhesive thin-film layers for generating a fluid control element that are provided above and below the non-adhesive thin-film layer for generating a micro-channel cooperate to enable partial closure of the micro-channel from above or below, whichever is desirable.

According to the micro-channel chip of the present invention, a holding lid fitted with O-rings that allows a means for pressure application and medium feeding to be connected to all ports at a time can be used in place of the conventional adapter type of means for pressure application and medium feeding. As a result, the efficiency of analytical operations can be improved outstandingly compared with the conventional case where the adapter type of means for pressure application and medium feeding is individually connected to each port.

### BRIEF DESCRIPTION OF THE DRAWINGS

FIG. 1 is a partial outline sectional view showing an embodiment of the micro-channel chip according to the present invention.

FIG. 2 is a partial outline sectional view showing how the micro-channel chip depicted in FIG. 1 is used.

FIG. 3 is a partial outline sectional view showing another embodiment of the micro-channel chip according to the present invention.

FIG. 4 is a partial outline sectional view showing how the micro-channel chip depicted in FIG. 3 has inflated in an area where a non-adhesive thin-film layer is provided.

FIG. 5 is an outline sectional view showing still another embodiment of the micro-channel chip according to the present invention.

FIG. 6 is a sectional view taken through FIG. 5 along line VI-VI.

FIG. 7 is an outline sectional view showing how the micro-channel chip 1B of the present invention as depicted in FIG. 6 works.

FIG. 8 is a partial outline enlarged sectional view taken through FIG. 7 along line VIII-VIII.

FIG. 9 is an outline sectional view showing a further embodiment of the micro-channel chip according to the present invention.

FIG. 10 is an outline sectional view showing how the micro-channel chip 1C of the present invention as depicted in FIG. 9 works.

FIG. 11 is a partial outline enlarged sectional view taken through FIG. 10 along line XI-XI.

FIG. 12 is an outline sectional view showing a still further embodiment of the micro-channel chip according to the present invention.

FIG. 13 is an outline sectional view showing a further embodiment of the micro-channel chip according to the present invention.

FIG. 14 is an outline sectional view showing another embodiment of the micro-channel chip according to the present invention.

FIG. 15 is an outline sectional view showing still another embodiment of the micro-channel chip according to the present invention.

FIG. 16 is an outline sectional view showing yet another embodiment of the micro-channel chip according to the present invention.

FIG. 17 shows in partial outline section two different embodiments of a recess formed in the underplate, one being defined by inclined sidewalls (17A) and the other by a curved surface (17B).

FIG. 18 is an outline transparent plan view showing a specific example of the pattern in the micro-channel chip of the present invention, in which an upside non-adhesive thin-film layer 27-U and a downside non-adhesive thin-film layer 27-D are provided as relative to the non-adhesive thin-film layer 17.

FIG. 19A is an outline plan view showing an example of the conventional micro-channel chip, and FIG. 19B is a sectional view taken through FIG. 19A along line B-B.

FIG. 20A is an outline plan view of the micro-channel chip that is described in the official gazette of WO 2007/094254 A1 and which has non-adhesive layers such that those areas which correspond to them have no channel capacity when the chip is not used but which, during its use, can be inflated by pressure application to form channels of a certain capacity, and FIG. 20B is a sectional view taken through FIG. 20A along line B-B.

FIG. 21A is a partial outline sectional view showing an adapter for pressure application and medium feeding as it has been connected to a port in the micro-channel chip depicted in FIG. 20A, and FIG. 21B is a partial outline sectional view showing the micro-channel chip as it has been supplied with a gas under pressure to inflate that area of the chip which corresponds to the non-adhesive thin-film layer so as to generate a void that functions as a channel.

### DESCRIPTION OF EMBODIMENTS

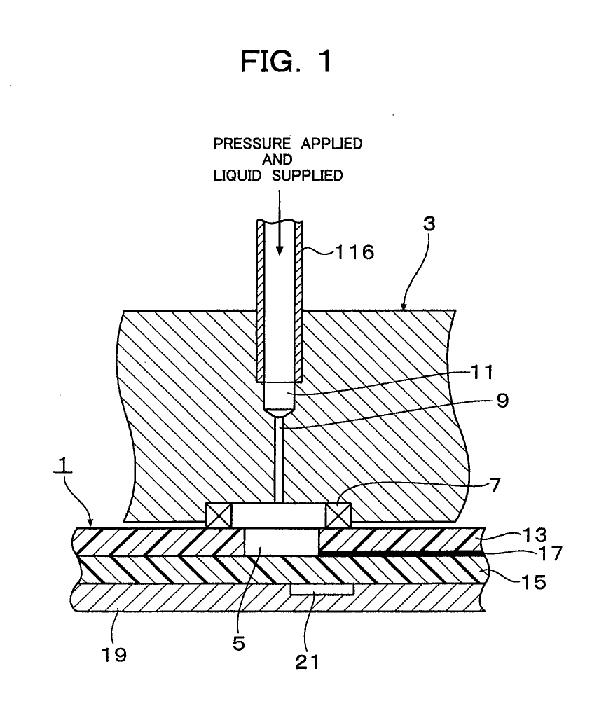

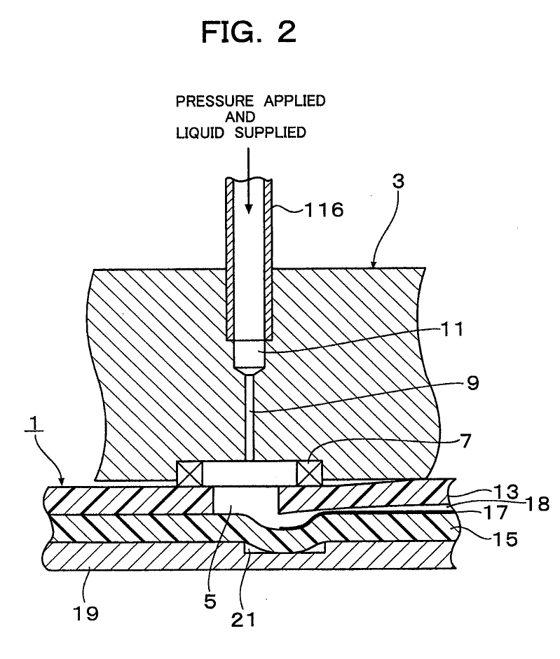

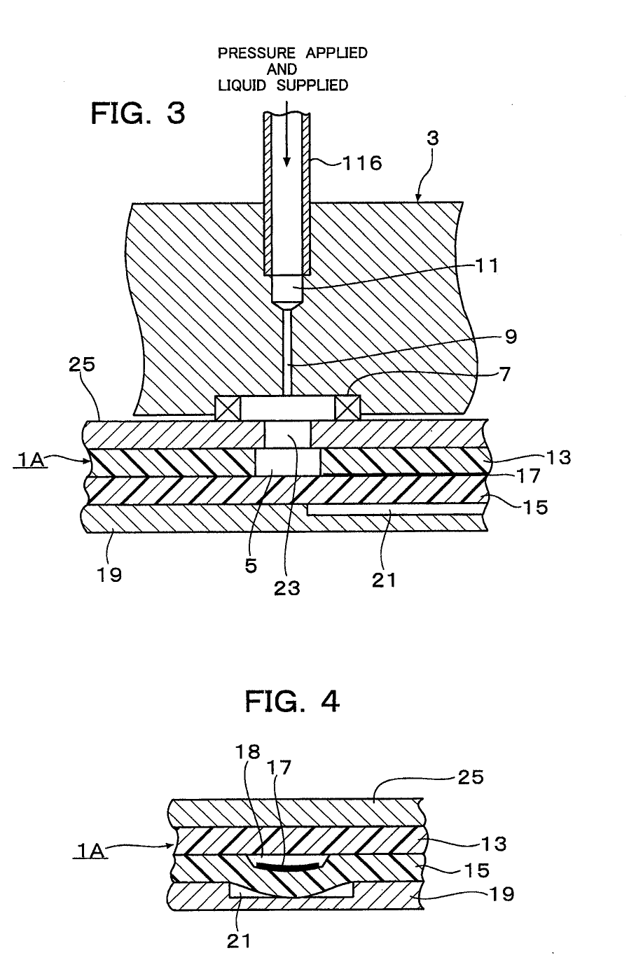

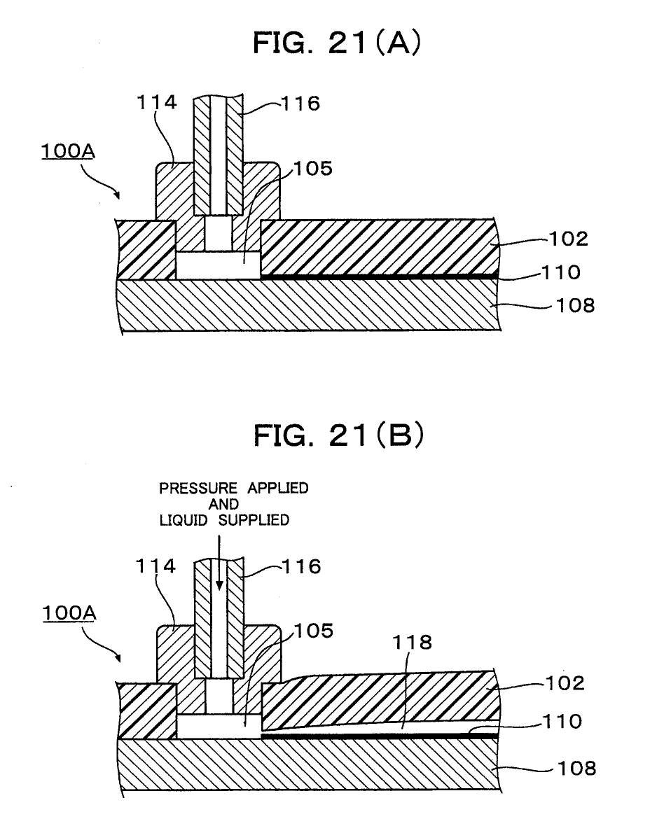

FIG. 1 is a partial outline sectional view showing an embodiment of the micro-channel chip according to the present invention. FIG. 2 is a partial outline sectional view showing how the micro-channel chip depicted in FIG. 1 is used. As shown in FIG. 1, the micro-channel chip of the present invention which is indicated by numeral 1 uses a holding lid 3 that covers the entire top of the micro-channel chip 1 in place of the conventional adapter 114 shown in FIG. 21. The holding lid 3 is a member in flat plate form that is made of a rigid material such as metals, plastics, glasses or ceramics. The holding lid 3 is fitted with an O-ring or an X-ring 7 in a position that corresponds to a port 5 in the micro-channel chip 1; the holding lid 3 has a through-hole 9 that communicates with the opening of the O-ring or X-ring 7, as well as a tube-connecting hole 11 that communicates with the through-hole 9. A feed tube 116 is inserted into the tube-connecting hole 11 and fixed. Although not shown, the tube-connecting hole 11 may be fitted with a known, conventional joint for connection to the feed tube 116. The advantage of using the holding lid 3 of the structure described above is that no matter how may ports the micro-channel chip 1 may have, a corresponding number of feed tubes 116 can be connected to the individual ports at a time. The O-ring or X-ring 7 may be formed of any material that can secure sealing of the port 5. Hence, any material selected from metals, plastics, rubbers, celluloses, etc may be used. The holding lid 3 is brought into detachable contact with the top surface of the micro-channel chip 1. Hence, although not shown, if the micro-channel chip 1 is always placed in the same area, the holding lid 3 as retained by a hinge mechanism may be urged against the top surface of the micro-channel chip 1 by a suitable means such as an openable/closable clamp mechanism and, after the micro-channel chip 1 has served its purpose, the clamp mechanism is released, whereupon the holding lid 3 springs upward, enabling the used micro-channel chip 1 to be replaced by a new one.

Turning back to FIG. 1, the micro-channel chip 1 of the present invention is such that both the first substrate 13 and the second substrate 15 are formed of a silicone rubber such as polydimethylsiloxane (PDMS). A non-adhesive thin-film layer 17 is formed in a predetermined area of the interface at which the first substrate 13 is bonded to the second substrate 15. The port 5 is connected to one end portion of the non-adhesive thin-film layer 17 in such a way that mutual communication can be established as required.

A feature of the micro-channel chip 1 of the present invention is that an underplate 19 made of a material that is difficult to deform by itself is provided on the underside of the second substrate 15; another feature is that a predetermined size of recess 21 is formed in the underplate 19 on the side where it makes an interface with the second substrate 15. The underplate 19 can be formed of any difficult-to-deform materials as defined above and they may be selected from among metals, plastics, rubbers, glasses, ceramics, woods, synthetic papers, etc. Plastics that are easy to mold are preferred. The thickness of the underplate 19 is not an essential requirement of the present invention but it is preferably within the range of 0.1 mm to 3 mm. If the thickness of the underplate 19 is less than 0.1 mm, its mechanical strength is unduly low and, what is more, a predetermined depth of recess 21 cannot be formed. On the other hand, if the thickness of the underplate 19 is more than 3 mm, diseconomy simply results since all functions that need be performed by the underplate 19 are already developed when it is 3 mm thick.

In the underplate 19 to be used in the present invention, the recess 21 is preferably formed in a position that is offset from the port 5 toward the non-adhesive thin-film layer 17. If the recess 21 is formed in the same position as the port 5, it is difficult to attain the intended effect. The depth of the recess 21 may be comparable to the height of a void that is to be formed when the first substrate 13 or the second substrate 15 is inflated in a position that corresponds to the non-adhesive thin-film layer 17. In addition, the width of the recess 21 is preferably greater than the width of the non-adhesive thin-film layer 17. If the width of the recess 21 is smaller than the width of the non-adhesive thin-film layer 17, it is difficult to attain the intended effect.

The underplate 19 to be used in the present invention may be secured to the underside of the second substrate 15 or, alternatively, it may be detachably provided on the underside of the second substrate 15. To allow for repeated use, it is preferred that the underplate 19 is detachably provided on the underside of the second substrate 15.

Reference is now made to FIG. 2. After the holding lid 3 is brought into contact with the first substrate 13, a gas such as air is supplied under pressure through the feed tube 116, whereupon that part of the second substrate 15 which corresponds to the recess 21 in the underplate 19 is pushed down into the recess 21, generating a small gap at the interface between the first substrate 13 and the second substrate 15, through which gap the high-pressure air gets into the interface between the first substrate 13 and the second substrate 15, whereby that part of the first substrate 13 which corresponds to the non-adhesive thin-film layer 17 is inflated to form a void 18 that should function as a micro-channel. If the recess 21 is formed in the same position as the port 5, it is difficult to generate a small gap at the interface between the first substrate 13 and the second substrate 15. In addition, if the width of the recess 21 is the same as or smaller than the width of the non-adhesive thin-film layer 17, it is difficult to generate a small gap at the interface between the first substrate 13 and the second substrate 15 and, what is more, that part of the first substrate 13 which corresponds to the non-adhesive thin-film layer 17 cannot be adequately inflated.

If a micro-channel chip in which the first substrate 13 and the second substrate 15 are each formed of PDMS is simply supplied with a gas (e.g. air) under pressure through the feed tube 116, with the holding lid 3 fitted with the O-ring or X-ring 7 being placed in contact with the top surface of the first substrate 13, that part of the first substrate 13 which corresponds to the non-adhesive thin-film layer 17 cannot be inflated. This is probably because the first substrate 13 and the second substrate 15, each made of PDMS (rubber), are altogether held down by the O-ring or X-ring 17, making it impossible to inflate the upper PDMS substrate 13. The present inventors have found that if an underplate having a recess formed in it is provided on the underside of the second substrate 15, that part of the first substrate 13 which corresponds to the non-adhesive thin-film layer 17 can be inflated at a fairly low pressure although both substrates are made of the same material PDMS (rubber).

FIG. 3 is a partial outline sectional view showing another embodiment of the micro-channel chip according to the present invention. If the holding lid 3 is depressed against the first substrate 13 which is made of PDMS, the latter might deflect to compromise the seal that should be provided by the O-ring 7. To solve this problem, an over-plate 25 having a through-hole 23 in a position that corresponds to the port 5 is provided on the topside of the first substrate 13. Like the underplate 19, the over-plate 25 may be formed of a rigid material such as metals, plastics, glasses, and ceramics. Plastics that are easy to mold are preferred. By providing the over-plate 25, the O-ring 17 could be completely prevented from failing to provide the intended seal but, on the other hand, it was impossible to inflate that part of the first substrate 13 that corresponded to the non-adhesive thin-film layer 17. To solve this problem, the recess 21 was formed in the underplate 19 in such a way that it extended to cover the entire length of the non-adhesive thin-film layer 17 and a part of the port 5. When a gas such as air was supplied into this structure under pressure through the feed tube 16, the part of the second substrate 15 which was in a position that corresponded to the non-adhesive thin-film layer 17 inflated as if it would sink into the recess 15, whereby a void 18 that would function as a micro-channel could be generated at the interface between the first substrate 13 and the second substrate 15. The over-plate 25 may be bonded to the top surface of the first substrate 13 or it may be detachably provided on the top surface of the first substrate 13.

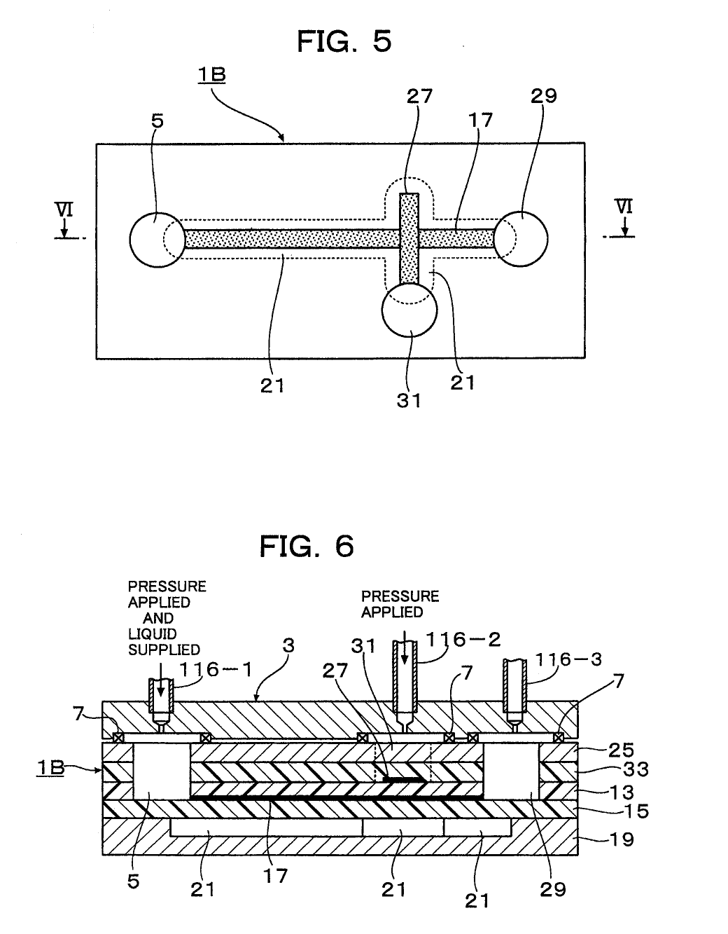

FIG. 5 is an outline sectional view showing still another embodiment of the micro-channel chip according to the present invention. FIG. 6 is a sectional view taken through FIG. 5 along line VI-VI. For the sake of explanation, the holding lid 3 is also depicted in FIG. 6. The micro-channel chip which is indicated by numeral 1B in FIGS. 5 and 6 has a third PDMS substrate 33 on the topside of the first substrate 13, with the over-plate 25 being provided on the topside of the third substrate 33. A non-adhesive thin-film layer 17 for generating a micro-channel is formed at the interface between the first substrate 13 and the second substrate 15, and a non-adhesive thin-film layer 27 for generating a fluid flow control element such as a valve is formed at the interface between the first substrate 13 and the third substrate 33. The non-adhesive thin-film layer 27 for generating a fluid flow control element such as a valve is formed in such a way that it covers only a part or the entire part of the non-adhesive thin-film layer 17 for generating a micro-channel. The recess 21 is formed in the underplate 19 to have a shape that corresponds to the non-adhesive thin-film layer 27 for generating a fluid flow control element such as a valve, and to the non-adhesive thin-film layer 17 for generating a micro-channel. The non-adhesive thin-film layer 17 for generating a micro-channel is connected to ports 5 and 29 in such a way that mutual communication is established as required whereas the non-adhesive thin-film layer 27 for generating a fluid flow control element such as a valve is connected to a port 31 in such a way that mutual communication is established as required. Placed in contact with the ports 5, 29 and 31 are O-rings 7 to which feed tubes 116-1, 116-3 and 116-2 are respectively connected.

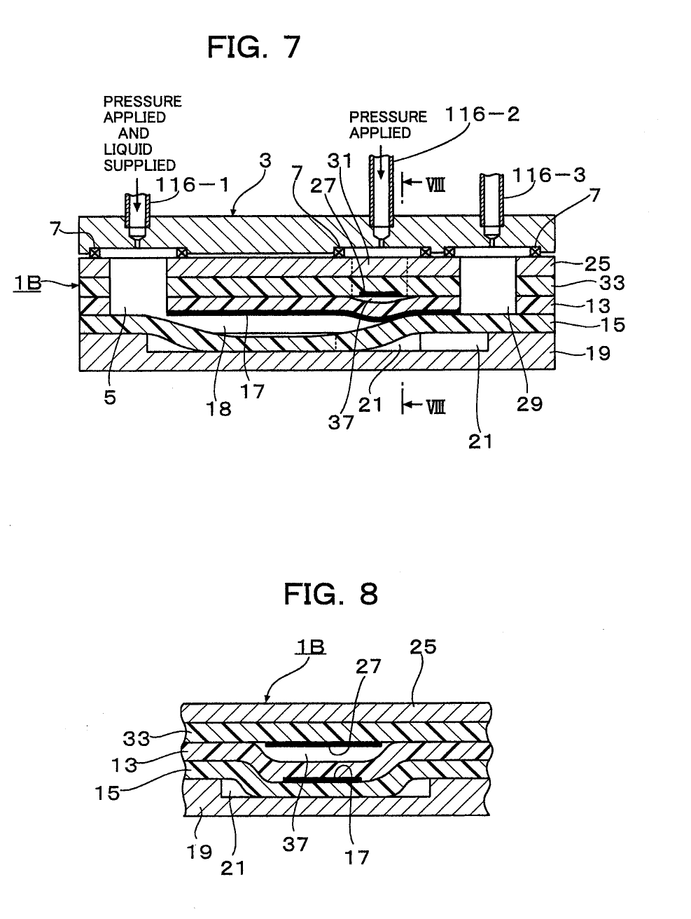

FIG. 7 is an outline sectional view showing how the micro-channel chip 1B of the present invention as depicted in FIG. 6 works. FIG. 8 is a partial outline enlarged sectional view taken through FIG. 7 along line VIII-VIII. Reference is now made to FIGS. 7 and 8. If pressurized air is supplied into the port 5 through the feed tube 116-1, that part of the second substrate 15 which corresponds to the position of the non-adhesive thin-film layer 17 inflates into the recess 21 to generate a void 18 that should serve as a micro-channel; if pressurized air is supplied into the port 31 through the feed tube 116-2, that part of the first substrate 13 which corresponds to the position of the non-adhesive thin-film layer 27 inflates toward the recess 21 to generate a depressing void 37, which then collapses the void 18 to close it. Thus, the part of the first substrate 13 which corresponds to the position of the non-adhesive thin-film layer 27 can function as a fluid control element such as a valve. In the case where the non-adhesive thin-film layer 27 for generating a fluid flow control element such as a valve is provided above the non-adhesive thin-film layer 17 for generating a micro-channel, the width of the recess 21 in the underplate 19 that corresponds to the position of the non-adhesive thin-film layer 27 is preferably greater than the width of this non-adhesive thin-film layer 27. The reason is that in order that the void 18 that should serve as a micro-channel can be collapsed and closed by the depressing void 37, the width of the recess 21 in the underplate 19 should be made sufficiently great to generate a wide enough depressing void 37 to cover the entire width of the underlying non-adhesive thin-film layer 17.

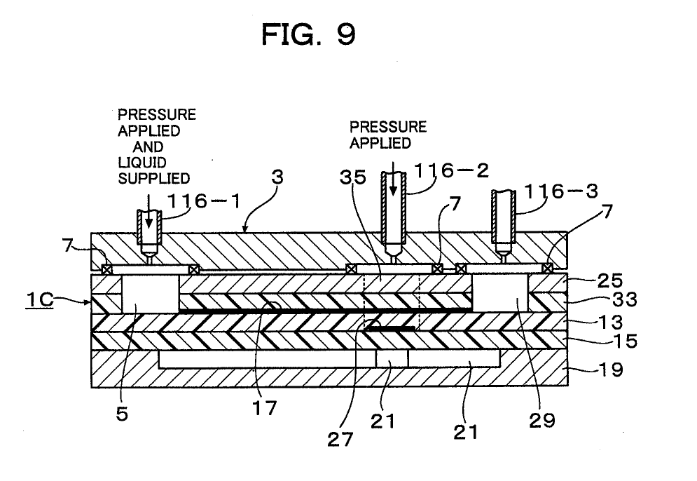

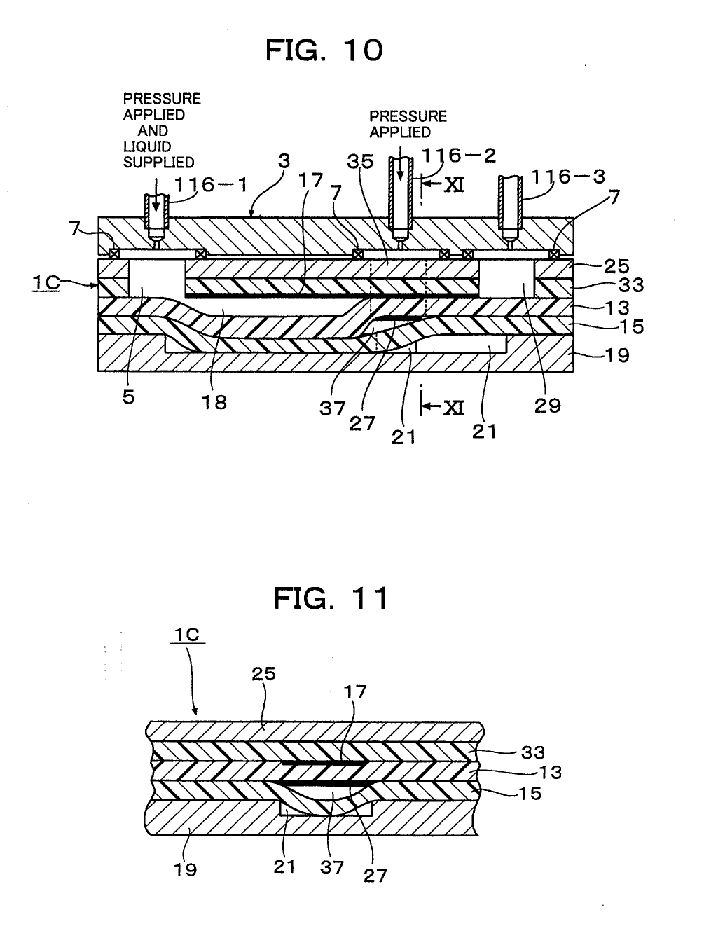

Alternatively, the non-adhesive thin-film layer 27 for generating a fluid flow control element such as a valve may be formed below the non-adhesive thin-film layer 17 for generating a micro-channel, as shown in FIG. 9. FIG. 10 is an outline sectional view showing how the micro-channel chip 1C of the present invention as depicted in FIG. 9 works. FIG. 11 is a partial outline enlarged sectional view taken through FIG. 10 along line XI-XI. Reference is made to FIGS. 10 and 11. If pressurized air is supplied into the port 5 through the feed tube 116-1, that part of the first substrate 13 which corresponds to the position of the non-adhesive thin-film layer 17 inflates toward the recess 21 to generate a void 18 that should serve as a micro-channel at the interface between the first substrate 13 and the third substrate 33; if pressurized air is supplied into the port 31 through the feed tube 116-2, that part of the second substrate 15 which corresponds to the position of the non-adhesive thin-film layer 27 inflates into the recess 21 to generate a depressing void 37 at the interface between the first substrate 13 and the second substrate 15; the depressing void 37 pushes the first substrate 13 toward the third substrate 33, whereby the void 18 that should serve as a micro-channel is collapsed and closed. Thus, the part of the first substrate 13 which corresponds to the position of the non-adhesive thin-film layer 27 can function as a fluid control element such as a valve. In the case where the non-adhesive thin-film layer 27 for generating a fluid flow control element such as a valve is provided below the non-adhesive thin-film layer 17 for generating a micro-channel, the width of the recess 21 in the underplate 19 that corresponds to the position of the non-adhesive thin-film layer 27 may be smaller than the width of this non-adhesive thin-film layer 27. The reason is that since the depressing void 37 pushes the first substrate 13 toward the third substrate 33 until the void 18 that should serve as a micro-channel is collapsed and closed, the second substrate 15 need be pushed into the recess 21 by only a small amount. It should, however, be noted that in the case where the non-adhesive thin-film layer 27 for generating a fluid flow control element such as a valve is provided below the non-adhesive thin-film layer 17 for generating a micro-channel, equally good results are obtained irrespective of whether the width of the recess 21 in the underplate 19 that corresponds to the position of the non-adhesive thin-film layer 27 is greater or smaller than the width of this non-adhesive thin-film layer 27.

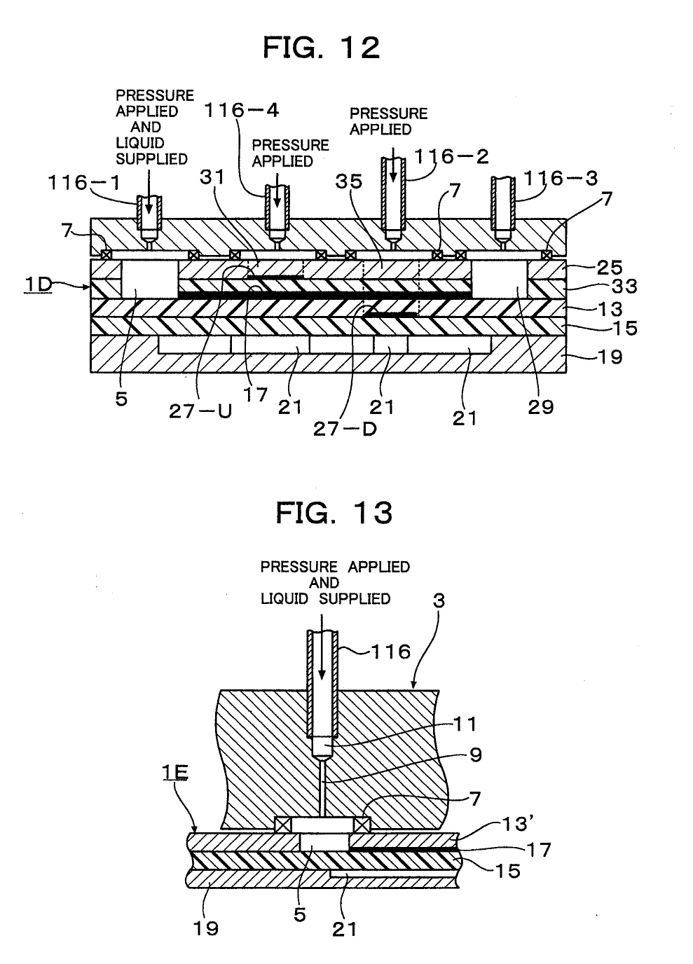

FIG. 12 is an outline sectional view showing a still further embodiment of the micro-channel chip according to the present invention. In the micro-channel chip indicated by numeral 1D, two non-adhesive thin-film layers 27-U and 27-D for generating a fluid control element such as a valve are provided on opposite sides (upside and downside) of the non-adhesive thin-film layer 17 for generating a micro-channel. In the embodiment shown in FIG. 12, an upside non-adhesive thin-film layer 27-U is provided at the interface between the over-plate 25 and the third substrate 33, the non-adhesive thin-film layer 17 is provided at the interface between the first substrate 13 and the third substrate 33, and a downside non-adhesive thin-film layer 27-D is provided at the interface between the first substrate 13 and the second substrate 15. An end portion of the upside non-adhesive thin-film layer 27-U may overlap an end portion of the downside non-adhesive thin-film layer 27-D.

FIG. 13 is an outline sectional view showing a further embodiment of the micro-channel chip according to the present invention. In the micro-channel chip 1 depicted in FIGS. 1 and 3, the first substrate 13 and the second substrate 15 are both made of a silicone rubber such as PDMS; in the micro-channel chip indicated by numeral 1E in FIG. 13, the first PDMS substrate 13 is replaced by the first substrate 13′ that is made of glass or other rigid materials that can be permanently bonded to the second PDMS substrate 15. Needless to say, rigid materials other than glass (say, plastics) may also be used as long as they can be permanently bonded to PDMS. This offers the advantage of obviating the use of the over-plate 25 which is made of a rigid material (see FIG. 3).

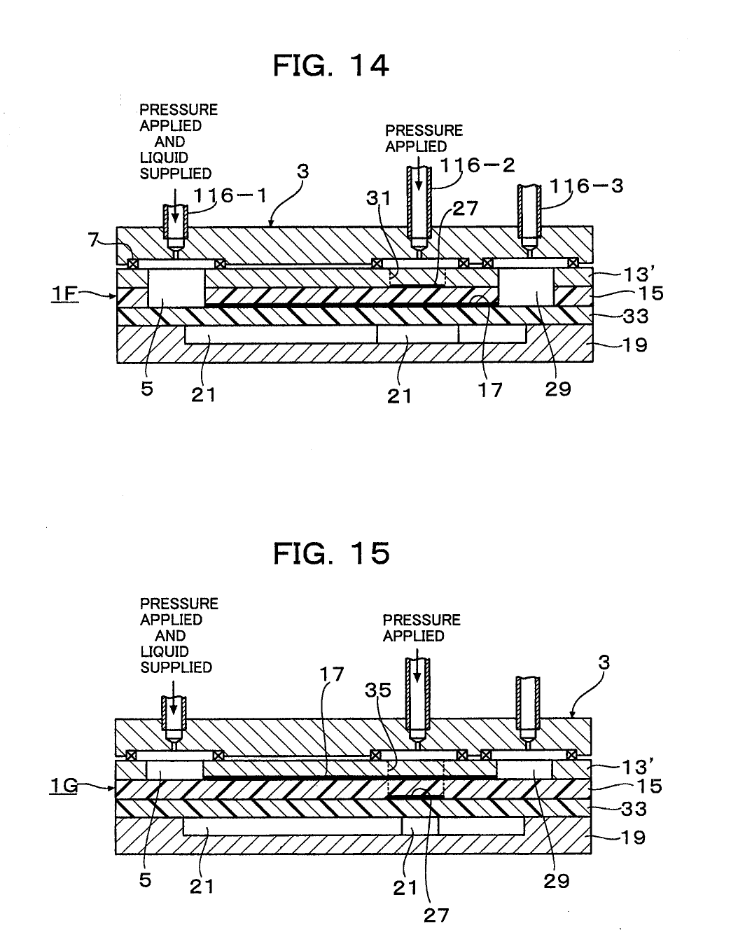

Consequently, the micro-channel chips 1B and 1C that are depicted in FIGS. 6 and 9 and which have the non-adhesive thin-film layer 27 for generating a fluid flow control element such as a valve have the structures depicted in FIGS. 14 and 15.

Reference is first made to FIG. 14. The micro-channel chip indicated by numeral 1F in FIG. 14 comprises, in order from top to bottom, the first substrate 13′ made of a rigid material such as glass or plastics, the second substrate 15 which is made of PDMS, the third substrate 33 which is also made of PDMS, and the underplate 19. The non-adhesive thin-film layer 27 for generating a fluid flow control element such as a valve is provided at the interface between the first substrate 13′ and the second substrate 15, and the non-adhesive thin-film layer 17 for generating a micro-channel is provided at the interface between the second substrate 15 and the third substrate 33. Therefore, in the micro-channel chip 1F, the third substrate 33 is first inflated into the recess 21 in the underplate 19 to generate a void that should serve as a micro-channel and, thereafter, that part of the second substrate 15 which corresponds to the position of the non-adhesive thin-film layer 27 is inflated toward the recess 21 to thereby collapse and close the void that should serve as a micro-channel. The underplate 19 may be secured to the third substrate 33 made of PDMS or, alternatively, it may be provided detachably on that substrate.

Reference is then made to FIG. 15. The micro-channel chip indicated by numeral 1G in FIG. 15 comprises, in order from top to bottom, the first substrate 13′ made of a rigid material such as glass or plastics, the second substrate 15 which is made of PDMS, the third substrate 33 which is also made of PDMS, and the underplate 19. The non-adhesive thin-film layer 17 for generating a micro-channel is provided at the interface between the first substrate 13′ and the second substrate 15, and the non-adhesive thin-film layer 27 for generating a fluid flow control element such as a valve is provided at the interface between the second substrate 15 and the third substrate 33. Therefore, in the micro-channel chip 1G, when that part of the third substrate 33 which corresponds to the position of the non-adhesive thin-film layer 27 is inflated into the recess 21 in the underplate 19, a depressing void is generated at the interface between the second substrate 15 and the third substrate 33 and this depressing void pushes the second substrate 15 toward the first substrate 13′, whereby the void that has been formed at the interface between the first substrate 13′ and the second substrate 15 to serve as a micro-channel is collapsed and closed.

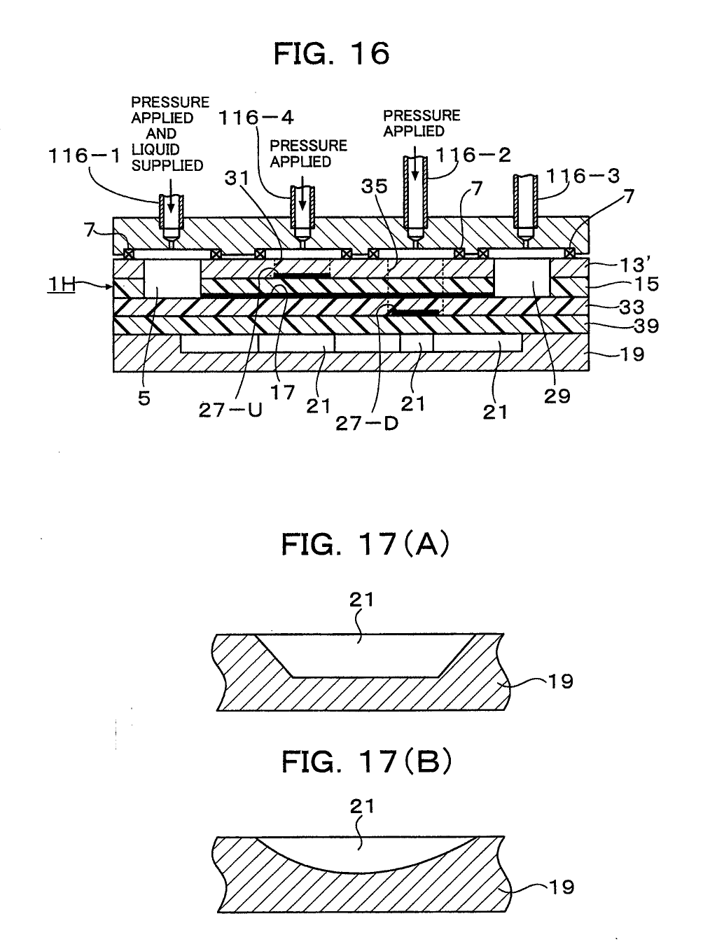

FIG. 16 shows a micro-channel chip 1H which is similar to the micro-channel chip 1D of FIG. 12 in that two non-adhesive thin-film layers 27-U and 27-D for generating a fluid control element such as a valve are provided on opposite sides (upside and downside) of the non-adhesive thin-film layer 17 for generating a micro-channel. The micro-channel chip 1H comprises, in order from top to bottom, the first substrate 13′ made of a rigid material such as glass or plastics, the second substrate 15 which is made of PDMS, the third substrate 33 which is also made of PDMS, a fourth PDMS substrate 39, and the underplate 19. An upside non-adhesive thin-film layer 27-U is provided at the interface between the first substrate 13′ and the second substrate 15 which is made of PDMS, the non-adhesive thin-film layer 17 is provided at the interface between the second substrate 15 and the third substrate 33, and a downside non-adhesive thin-film layer 27-D is provided at the interface between the third substrate 33 and the fourth substrate 39. An end portion of the upside non-adhesive thin-film layer 27-U may overlap an end portion of the downside non-adhesive thin-film layer 27-D. The underplate 19 may be secured to the fourth PDMS substrate 39 or, alternatively, it may be provided detachably on that substrate.

In each of the foregoing embodiments, the recess 21 formed in the underplate 19 is shown to have a sectional profile defined by vertical sidewalls but this is not the sole case of the present invention and other profiles are possible, such as the one that is defined by oblique sidewalls as shown in FIG. 17A or the one that is defined by a curved surface as shown in FIG. 17B.

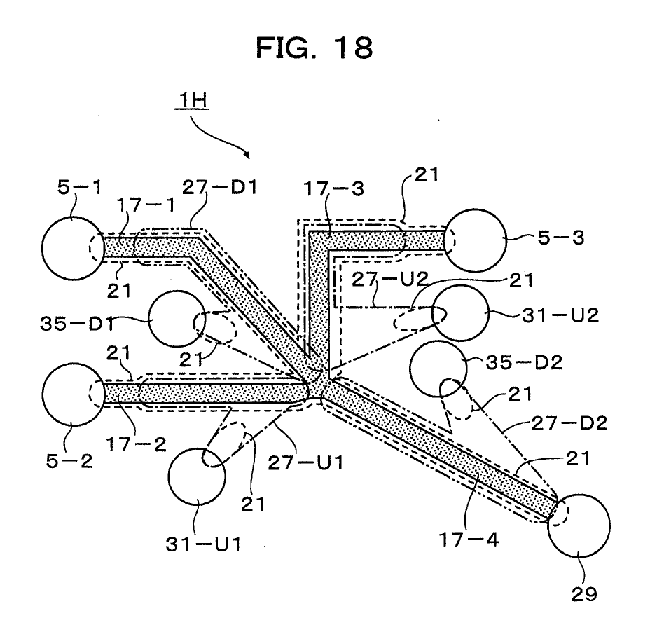

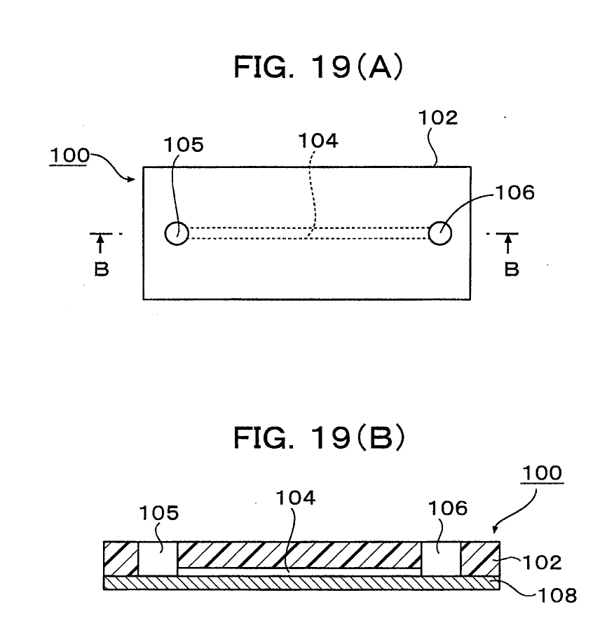

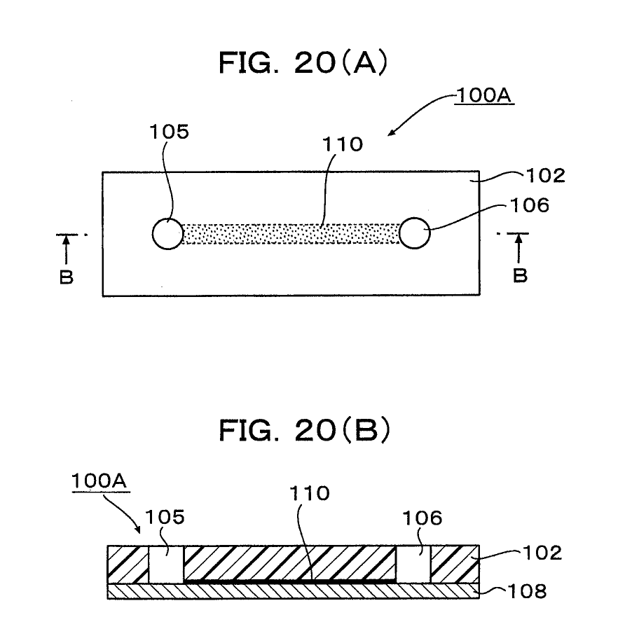

FIG. 18 is an outline transparent plan view showing a specific example of the pattern in the micro-channel chip of the present invention, in which an upside non-adhesive thin-film layer 27-U and a downside non-adhesive thin-film layer 27-D are provided as relative to the non-adhesive thin-film layer 17. Ports 5-1, 5-2 and 5-3 are used to feed air and/or liquids under pressure. Port 29 is used for various purposes, typically as air drain or liquid reservoir. The dotted areas in FIG. 18 that are delineated by solid lines represent patches of the non-adhesive thin-film layer 17 for generating a micro-channel. The areas delineated by broken lines represent the recesses 21 in the underplate. The areas delineated by one-short-one-long dashed lines represent patches of the upside non-adhesive thin-film layer 27-U for generating a fluid control element. The areas delineated by two-short-one-long dashed lines represent patches of the downside non-adhesive thin-film layer 27-D for generating a fluid control element. The patches of upside non-adhesive thin-film layer 27-U1 and 27-U2 are respectively connected to pressurized-air feeding ports 31-U1 and 31-U2 in such a way that mutual communication is established as required. Similarly, the patches of downside non-adhesive thin-film layer 27-D1 and 27-D2 are respectively connected to pressurized-air feeding ports 35-D1 and 35-D2 in such a way that mutual communication is established as required. Consider, for example, the case where a liquid is to be sent from the port 5-1 to the port 29; first, pressurized air is fed in through the ports 31-U1 and 31-U2 to depress the patches of non-adhesive thin-film layer 17-2 and 17-3 that correspond to the patches of upside non-adhesive thin-film layer 27-U1 and 27-U2, respectively, so that no liquid will flow into the ports 5-2 and 5-3; only thereafter is started the operation of feeding the liquid into the port 5-1. By thusly using the appropriate combination of the patches of upside non-adhesive thin-film layer 27-U1 and 27-U2 with the patches of downside non-adhesive thin-film layer 27-D1 and 27-D2, the liquids of interest can be accurately delivered to the intended ports. As shown in FIG. 18, the patches of upside non-adhesive thin-film layer 27-U1 and 27-U2 overlap the patch of downside non-adhesive thin-film layer 27-D1 in the area near the point where the patches of non-adhesive thin-film layer 17-1, 17-2 and 17-3 converge. This design is intended to provide an enhanced liquid sealing effect. Needless to say, the pattern layout of the upside non-adhesive thin-film layer 27-U and the downside non-adhesive thin-film layer 27-D as relative to the non-adhesive thin-film layer 17 may be modified in ways other than the embodiment depicted in FIG. 18. For example, patterns in combination of the patches of non-adhesive thin-film layer 17-1, 17-2, 17-3 and 17-4, the patches of upside non-adhesive thin-film layer 27-U1 and 27-U2, and the patches of downside non-adhesive thin-film layer 27-D1 and 27-D2 may be provided around the port 29.

In each of the foregoing embodiments, the thicknesses of the individual substrates are not drawn to scale but exaggerated for the sake of explanation and they typically range from 100 μm to 3 mm. If the thickness of the substrates is less than 100 μm, they are difficult to handle and the efficiency of operations in the manufacture of micro-channel chips is lowered. If, on the other hand, the thickness of the substrates is more than 100 μm, unduly high pressure is required to inflate them and the chip itself may potentially be destroyed by such high pressure.

The non-adhesive thin-film layers 17 and 27 may be formed on either one or both sides of the interface at which two substrates are bonded together. The thicknesses of the non-adhesive thin-film layers, the materials of which they are to be formed, the methods of forming them, and other information are given in detail in WO 2007/094254 A1 (Patent Document 3) and US 2008/0057274 A1 (Patent Document 4), which are both incorporated herein by reference.

On the foregoing pages, the preferred embodiments of the micro-channel chip of the present invention have been described in a specific manner but it should be understood that the present invention is by no means limited to the disclosed embodiments and can be modified in various ways. For example, the holding lid fitted with O-rings or X-rings may be replaced by the conventional adapter type of means for pressure application and medium feeding.

According to the present invention, the efficiency of analysis using the micro-channel chip is improved outstandingly, which contributes to a marked enhancement in its practical feasibility and economy. As a result, the micro-channel chip of the present invention finds effective and advantageous use in various fields including medicine, veterinary medicine, dentistry, pharmacy, life sciences, foods, agriculture, fishery, and police forensics. In particular, the micro-channel chip of the present invention is optimum for use in the fluorescent antibody technique and in-situ hybridization and can be used inexpensively in a broad range of applications including testing for immunological diseases, cell culture, virus fixation, pathological test, cytological diagnosis, biopsy tissue diagnosis, blood test, bacteriologic examination, protein analysis, DNA analysis, and RNA analysis.

1. A micro-channel chip comprising:
a first substrate and a second substrate bonded together, at least one patch of a non-adhesive thin-film layer for generating a micro-channel is formed on a mating surface of at least one of the two substrates,
a port is open to the atmosphere is connected to the first substrate, and at least one end portion of the non-adhesive thin-film layer is communicably connected to the port,
an underplate made of a material that is difficult to deform by itself is provided on an underside of the second substrate, the underplate has a recess at the interface with the second substrate that extends from a position that is short of the center of the port toward the non-adhesive thin-film layer, and the width of the recess is greater than that of the non-adhesive thin-film layer.

2. The micro-channel chip according to claim 1, wherein the recess extends from a position that is short of the center of the port to cover only a part of the length of the non-adhesive thin-film layer.

3. The micro-channel chip according to claim 1, wherein the recess extends from a position that is short of the center of the port to cover the entire length of the non-adhesive thin-film layer.

4. The micro-channel chip according to claim 1, wherein the first substrate is made of a rigid material that can be permanently bonded to polydimethylsiloxane (PDMS) whereas the second substrate is made of PDMS.

5. The micro-channel chip according to claim 1, wherein the both the first substrate and the second substrate are made of PDMS.

6. The micro-channel chip according to claim 5, wherein the first substrate made of PDMS is provided on its top with an over-plate made of a rigid material.

7. The micro-channel chip according to claim 1, wherein the underplate is formed of at least one material selected from the group consisting of metals, plastics, rubbers, glasses, ceramics, woods, and synthetic papers and is either bonded to or detachably provided on the underside of the second substrate.

8. A micro-channel chip comprising, in order from top to bottom, a
first substrate, a second substrate, and a third substrate bonded together, at least one patch of a non-adhesive thin-film layer for generating a fluid control element is formed on a mating surface of at least one substrate selected from between the first substrate and the second substrate,
at least one patch of a non-adhesive thin-film layer for generating a micro-channel is formed on the mating surface of at least one substrate selected from between the second substrate and the third substrate,
wherein the non-adhesive thin-film layer for generating a fluid control element is formed in such a way that it overlaps, with the second substrate being interposed, at least a part of the non-adhesive thin-film layer for generating a micro-channel, and the first substrate is provided with a first port and a second port,
wherein the first port being deep enough to reach the second substrate for opening to the atmosphere and to which at least one end portion of the non-adhesive thin-film layer for generating a micro-channel is communicably connected, and
wherein the second port being open to the atmosphere and to which at least one end portion of the non-adhesive thin-film layer for generating a fluid control element is communicably connected,
wherein an underplate made of a material that is difficult to deform by itself is provided on the underside of the third substrate, the underplate has a first recess and a second recess provided at the interface with the third substrate,
wherein the first recess extending from a position that is short of the center of the first port toward the non-adhesive thin-film layer for generating a micro-channel,
wherein the second recess extending from a position in that part of the non-adhesive thin-film layer for generating a fluid control element which does not overlap the non-adhesive thin-film layer for generating a micro-channel and that is short of the center of the second port toward the non-adhesive thin-film layer for generating a fluid control element in that part which does not overlap the non-adhesive thin-film layer for generating a micro-channel,
wherein a width of the first recess being greater than that of the non-adhesive thin-film layer for generating a micro-channel, as well as a width of the non-adhesive thin-film layer for generating a fluid control element in the part which overlaps the non-adhesive thin-film layer for generating a micro-channel.

9. A micro-channel chip comprising, in order from top to bottom, a
first substrate, a second substrate, and a third substrate bonded together,
at least one patch of a non-adhesive thin-film layer for generating a micro-channel is formed on a mating surface of at least one substrate selected from between the first substrate and the second substrate,
at least one patch of a non-adhesive thin-film layer for generating a fluid control element is formed on the mating surface of at least one substrate selected from between the second substrate and the third substrate, the non-adhesive thin-film layer for generating a fluid control element is formed in such a way that it overlaps, with the second substrate being interposed, at least a part of the non-adhesive thin-film layer for generating a micro-channel,
wherein the first substrate is provided with a first port and a second port, the first port being open to the atmosphere and to which at least one end portion of the non-adhesive thin-film layer for generating a micro-channel is communicably connected, and
wherein the second port being deep enough to reach the second substrate for opening to the atmosphere and to which at least one end portion of the non-adhesive thin-film layer for generating a fluid control element is communicably connected,
an underplate made of a material that is difficult to deform by itself is provided on the underside of the third substrate, the underplate has a first recess and a second recess provided at the interface with the third substrate,
wherein the first recess extending from a position that is short of the center of the first port toward the non-adhesive thin-film layer for generating a micro-channel,
wherein the second recess extending from a position in that part of the non-adhesive thin-film layer for generating a fluid control element which does not overlap the non-adhesive thin-film layer for generating a micro-channel and that is short of the center of the second port toward the non-adhesive thin-film layer for generating a fluid control element in the part which does not overlap the non-adhesive thin-film layer for generating a micro-channel,
wherein a width of the first recess being greater than that of the non-adhesive thin-film layer for generating a micro-channel but smaller than the width of the non-adhesive thin-film layer for generating a fluid control element in the part which overlaps the non-adhesive thin-film layer for generating a micro-channel.

10. The micro-channel chip according to claim 8, wherein the first recess extends from a position that is short of the center of the first port to cover the entire length of the non-adhesive thin-film layer for generating a micro-channel.

11. The micro-channel chip according to claim 8, wherein the second recess extends from a position that is short of the center of the second port to cover only a part of the length of the non-adhesive thin-film layer for generating a fluid control element.

12. The micro-channel chip according to claim 8, wherein the first substrate is made of a rigid material that can be permanently bonded to polydimethylsiloxane (PDMS), the second substrate is made of PDMS, and the third substrate is also made of PDMS.

13. The micro-channel chip according to claim 8, wherein the first substrate, the second substrate, and the third substrate are each made of PDMS.

14. The micro-channel chip according to claim 13, wherein the first substrate made of PDMS is provided on its top with an over-plate made of a rigid material.

15. The micro-channel chip according to claim 8, wherein the underplate is formed of at least one material selected from the group consisting of metals, plastics, rubbers, glasses, ceramics, woods, and synthetic papers and is either bonded to or detachably provided on the underside of the third substrate.

16. A micro-channel chip comprising, in order from top to bottom, a first substrate, a second substrate, a third substrate, and a fourth substrate bonded together,
at least one patch of a first non-adhesive thin-film layer for generating a fluid control element is formed on a mating surface of at least one substrate selected from between the first substrate and the second substrate,
at least one patch of a non-adhesive thin-film layer for generating a micro-channel is formed on a mating surface of at least one substrate selected from between the second substrate and the third substrate, and
at least one patch of a second non-adhesive thin-film layer for generating a fluid control element is formed on a mating surface of at least one substrate selected from between the third substrate and the fourth substrate, wherein the first non-adhesive thin-film layer for generating a fluid control element is formed in such a way that it overlaps, with the second substrate being interposed, at least a part of the non-adhesive thin-film layer for generating a micro-channel,
wherein the second non-adhesive thin-film layer for generating a fluid control element is formed in such a way that it overlaps, with the third substrate being interposed, at least a part of the non-adhesive thin-film layer for generating a micro-channel, and
wherein the first substrate is provided with a first port, a second port, and a third port,
wherein the first port being deep enough to reach the second substrate for opening to the atmosphere and to which at least one end portion of the non-adhesive thin-film layer for generating a micro-channel is communicably connected,
wherein the second port being open to the atmosphere and to which at least one end portion of the first non-adhesive thin-film layer for generating a fluid control element is communicably connected, and
wherein the third port being deep enough to reach the third substrate for opening to the atmosphere and to which at least one end portion of the second non-adhesive thin-film layer for generating a fluid control element is communicably connected,
an underplate made of a material that is difficult to deform by itself is provided on the underside of the fourth substrate, the underplate has a first recess, a second recess, and a third recess provided at the interface with the fourth substrate,
wherein the first recess extending from a position that is short of the center of the first port toward the non-adhesive thin-film layer for generating a micro-channel,
wherein the second recess extending from a position in that part of the first non-adhesive thin-film layer for generating a fluid control element which does not overlap the non-adhesive thin-film layer for generating a micro-channel and that is short of the center of the second port toward that part of the first non-adhesive thin-film layer for generating a fluid control element which does not overlap the non-adhesive thin-film layer for generating a micro-channel,
wherein the third recess extending from a position in that part of the second non-adhesive thin-film layer for generating a fluid control element which does not overlap the non-adhesive thin-film layer for generating a micro-channel and that is short of the center of the third port toward the second non-adhesive thin-film layer for generating a fluid control element in that part which does not overlap the non-adhesive thin-film layer for generating a micro-channel,
wherein a width of the first recess being greater than that of the non-adhesive thin-film layer for generating a micro-channel as well as the width of the first non-adhesive thin-film layer for generating a fluid control element in that part which overlaps the non-adhesive thin-film layer for generating a micro-channel but smaller than the width of the second non-adhesive thin-film layer for generating a fluid control element in that part which overlaps the non-adhesive thin-film layer for generating a micro-channel.

17. The micro-channel chip according to claim 16, wherein the first recess extends from a position that is short of the center of the first port to cover the entire length of the non-adhesive thin-film layer for generating a micro-channel.

18. The micro-channel chip according to claim 16, wherein the second recess extends from a position that is short of the center of the second port to cover only a part of the length of the first non-adhesive thin-film layer for generating a fluid control element.

19. The micro-channel chip according to claim 16, wherein the third recess extends from a position that is short of the center of the third port to cover only a part of the length of the second non-adhesive thin-film layer for generating a fluid control element.

20. The micro-channel chip according to claim 16, wherein the first substrate is made of a rigid material that can be permanently bonded to polydimethylsiloxane (PDMS) whereas the second substrate, the third substrate, and the fourth substrate are each made of PDMS.

21. The micro-channel chip according to claim 16, wherein the underplate is formed of at least one material selected from the group consisting of metals, plastics, rubbers, glasses, ceramics, woods, and synthetic papers and is either bonded to or detachably provided on the underside of the fourth substrate.
